(19) United States
(12) Patent Application Publication
(10) Pub. No.: US 2017/0197619 A1
(43) Pub. Date: Jul. 13, 2017

(54) VEHICLE SPEED CONTROL SYSTEM AND METHOD FOR LOW SPEED SITUATION OR SLIPPERY ENVIRONMENT

(71) Applicant: Jaguar Land Rover Limited, Whitley, Coventry, Warwickshire, OT (GB)

(72) Inventor: James Kelly, Solihull, West Midlands (GB)

(21) Appl. No.: 15/313,799

(22) PCT Filed: Apr. 15, 2015
(86) PCT No.: PCT/EP2015/058150

§ 371 Date: Nov. 23, 2016

(30) Foreign Application Priority Data
May 23, 2014 (GB) 1409181.3

(51) Int. Cl. B60W 30/14; B60W 10/04; B60W 10/18

(52) U.S. Cl. CPC B60W 30/143; B60W 10/18; B60W 10/04; B60W 2510/0208; B60W 2510/105; B60W 2720/103; B60W 2540/14

(57) ABSTRACT

A speed control system for automatically controlling the speed of a vehicle in accordance with a target speed value. The speed control system carries out a method that includes: causing automatically a vehicle to travel at a required speed value at least in part by controlling an amount of torque applied to one or more wheels of a vehicle by a powertrain; causing automatically a change in the required speed value according to a predetermined speed profile thereby to cause a corresponding change in a measured instant speed of a vehicle; and determining automatically when a powertrain torque interruption occurs. The system is configured temporarily to cause a suspension of changes in required speed value according to the predetermined speed profile when it is determined that a powertrain torque interruption occurs.

### INCORPORATION BY REFERENCE

The content of UK patent applications GB2492748, GB2492655 and GB2499252 is incorporated herein by reference.

### TECHNICAL FIELD

The present invention relates to vehicle speed control systems. In particular but not exclusively the invention relates to monitoring of vehicle speed control systems to ensure correct operation.

### BACKGROUND

In known vehicle speed control systems, typically referred to as cruise control systems, the vehicle speed is maintained on-road once set by the user without further intervention by the user so as to improve the driving experience for the user by reducing workload.

With typical cruise control systems, the user selects a speed at which the vehicle is to be maintained, referred to as a set-speed, and the vehicle is maintained at a target speed that is set equal to the set-speed for as long as the user does not apply a brake or, in the case of a vehicle having a manual transmission, depress a clutch pedal. The cruise control system takes its speed signal from a driveshaft speed sensor or wheel speed sensors. When the brake or the clutch is depressed, the cruise control system is disabled so that the user can override the cruise control system to change the vehicle speed without resistance from the system. If the user depresses the accelerator pedal by a sufficient amount the vehicle speed will increase, but once the user removes his foot from the accelerator pedal the vehicle reverts to the pre-set cruise speed (set-speed) by coasting.

Such systems are usually operable only above a certain speed, typically around 15-20 kph, and are ideal in circumstances in which the vehicle is travelling in steady traffic conditions, and particularly on highways or motorways. In congested traffic conditions, however, where vehicle speed tends to vary widely, cruise control systems are ineffective, and especially where the systems are inoperable because of a minimum speed requirement. A minimum speed requirement is often imposed on cruise control systems so as to reduce the likelihood of low speed collision, for example when parking. Such systems are therefore ineffective in certain driving conditions (e.g. low speed) and are set to be automatically disabled in circumstances in which a user may not consider it to be desirable to do so.

More sophisticated cruise control systems are integrated into the engine management system and may include an adaptive functionality which takes into account the distance to the vehicle in front using a radar-based system. For example, the vehicle may be provided with a forward-looking radar detection system so that the speed and distance of the vehicle in front is detected and a safe following speed and distance is maintained automatically without the need for user input. If the lead vehicle slows down, or another object is detected by the radar detection system, the system sends a signal to the engine or the braking system to slow the vehicle down accordingly, to maintain a safe following distance.

Known cruise control systems also cancel in the event that a wheel slip event is detected requiring intervention by a traction control system (TC system or TCS) or stability control system (SCS). Accordingly, they are not well suited to maintaining vehicle progress when driving in off road conditions where such events may be relatively common.

It is an aim of embodiments of the present invention to address disadvantages associated with the prior art.

### SUMMARY OF THE INVENTION

Embodiments of the invention may be understood with reference to the appended claims.

Aspects of the present invention provide a system, a vehicle and a method.

In one aspect of the invention for which protection is sought there is provided a speed control system for automatically controlling the speed of a vehicle in accordance with a target speed value, the system comprising:

means for causing automatically a vehicle to travel at a required speed value at least in part by controlling an amount of torque applied to one or more wheels of a vehicle by a powertrain;

means for causing automatically a change in the required speed value according to a predetermined speed profile thereby to cause a corresponding change in a measured instant speed of a vehicle; and

means for determining automatically when a powertrain torque interruption occurs,

the system being configured temporarily to cause a suspension of changes in required speed value according to the predetermined speed profile when it is determined that a powertrain torque interruption occurs.

Thus it is to be understood that the system causes a change in the value of the required speed value and, consequently, a corresponding change in the measured instant speed of travel of the vehicle over ground. The value of the required speed value is no longer changed according to the predetermined speed profile when a powertrain torque interruption occurs.

Such a control system has the advantage that a reduction in vehicle composure due to a relatively rapid increase in the amount of powertrain torque applied to one or more wheels of a vehicle following a period of powertrain torque interruption may be prevented, or the amount of the reduction in composure reduced, when vehicle speed is being controlled automatically by a speed control system.

It is to be understood that the speed control system may be configured to cause an increase or decrease in the amount of powertrain torque applied to one or more wheels as required in order to cause the measured instant vehicle speed (which may also be referred to as a vehicle reference speed) to be substantially equal to the required speed value. The amount of positive powertrain torque applied to a wheel may be increased by increasing the amount of positive drive torque developed by a powertrain. The amount of negative powertrain torque may be increased by increasing the amount of braking torque developed by a powertrain. In the case of an internal combustion engine this may be accomplished by reducing an amount of air or fuel flow. In the case of an electric machine this may be accomplished by operating the electric machine as a generator with an increased value of negative torque applied by the electric machine to an input thereof.

Optionally, the means for causing automatically a vehicle to travel at a required speed value, and the means for causing a change in required speed value according to a predetermined speed profile, comprise an electric controller, the electric controller being configured to output a signal to cause a powertrain to apply a required amount of powertrain torque to one or more wheels of a vehicle.

Optionally, the electric controller is configured to determine the required amount of powertrain torque in dependence upon the difference between the instant speed of the vehicle and the required speed value.

Optionally, the electric controller is configured to determine the required amount of powertrain torque in dependence upon the magnitude of the difference between the instant speed of the vehicle and the required speed value.

Optionally, the means for determining automatically when a powertrain torque interruption occurs comprises the electric controller being configured to receive electrical signals indicative of when a powertrain torque interruption occurs.

Optionally, the means for determining automatically when a powertrain torque interruption occurs comprises the electric controller being configured to receive one or more electrical signals indicative of a gear change taking place.

Optionally, the system may be configured to resume changes in required speed value according to the predetermined speed profile in dependence upon receipt of one or more electrical signals indicative that powertrain torque interruption has ceased.

Optionally resumption may take place according to the predetermined speed profile from a speed value of the profile substantially equal to the instant speed of a vehicle when the torque interruption ceases.

This feature has the advantage that the system is able to compensate for any change in instant vehicle speed during the period of torque interruption such that tracking of the profile resumes at a location of or point on the profile corresponding to instant speed.

Optionally the system may be configured substantially to prevent a change in required speed value during the period of powertrain torque interruption.

Optionally the system may be configured to limit a rate of change of required speed value, or to limit an amount by which the required speed value may change, during the period of powertrain torque interruption.

Optionally said electronic controller may comprise a proportional-integral (PI) feedback control portion, the PI control portion comprising a proportional element configured to output a proportional signal that is proportional to a difference between the instant vehicle speed and required speed value, and an integral element configured to output an integral signal that corresponds to an integrated value over time of the difference between the instant vehicle speed and the required speed value, wherein during a period of torque interruption the system is configured substantially to suspend changes in the proportional signal and the integral signal.

This feature has the advantage of further reducing any loss of vehicle composure following a period of torque interruption, when a powertrain resumes application of torque to one or more wheels, due to relatively large and rapid changes in vehicle rate of acceleration (positive or negative) as a consequence of control of vehicle speed by the system.

In a further aspect of the invention for which protection is sought there is provided a vehicle comprising a body, a plurality of wheels, a powertrain to drive said wheels, a braking system to brake said wheels, and a system according to any one of the preceding claims.

In another aspect of the invention for which protection is sought there is provided a method of automatically controlling the speed of a vehicle in accordance with a target speed value implemented by means of a control system, said method comprising: causing automatically a vehicle to travel at a required speed value at least in part by controlling an amount of torque applied to one or more wheels of a vehicle by a powertrain;

causing automatically a change in the required speed value according to a predetermined speed profile thereby to cause a corresponding change in a measured instant speed of a vehicle v_ref; and

determining automatically when a powertrain torque interruption occurs,

the method comprising substantially temporarily causing a suspension of changes in required speed value inst_tgt_spd according to the predetermined speed profile when it is determined that a powertrain torque interruption occurs.

Optionally, determining automatically when a powertrain torque interruption occurs comprises determining automatically when a transmission gear change occurs.

Optionally, determining automatically when a transmission gear change occurs comprises receiving a signal indicative of a transmission gear change.

In one aspect of the invention for which protection is sought there is provided a carrier medium carrying computer readable code for controlling a vehicle to carry out the method of another aspect.

In one aspect of the invention for which protection is sought there is provided a computer program product executable on a processor so as to implement the method of another aspect.

In one aspect of the invention for which protection is sought there is provided a computer readable medium loaded with the computer program product of another aspect.

In one aspect of the invention for which protection is sought there is provided a processor arranged to implement the method of another aspect.

In a further aspect of the invention for which protection is sought there is provided a speed control system for a vehicle, comprising:

means for automatically causing a vehicle to operate in accordance with a target speed value;

means for causing an increase or decrease in speed of a vehicle according to predetermined speed profile information indicative of a required speed profile, in order to cause vehicle speed to track the predetermined speed profile; and

means for determining when a powertrain torque interruption occurs due to a gear shift,

the system being configured to time-shift at least a remaining portion of the predetermined speed profile by an amount responsive to the period over which the torque interruption occurs due to the gear shift.

In one aspect of the invention for which protection is sought there is provided a speed control system for automatically controlling the speed of a vehicle in accordance with a target speed value, the system comprising:

means for reducing automatically a difference between a reference speed value corresponding to an instant speed of a vehicle, and an instant target speed parameter corresponding to a required value of instant vehicle speed, at least in part by controlling an amount of powertrain torque applied to one or more wheels of a vehicle by a powertrain;

means for causing a change in instant vehicle speed by causing a corresponding change in instant target speed parameter according to a predetermined target speed profile; and

means for determining when a powertrain torque interruption occurs,

the system being configured to temporarily cause a suspension of changes in instant target speed parameter according to the predetermined speed profile when it is determined that a powertrain torque interruption occurs.

In a further aspect of the invention for which protection is sought there is provided a method of operating a speed control system of a vehicle implemented by means of a control system, said method comprising:

reducing automatically a difference between an instant speed of a vehicle and an instant target speed parameter corresponding to a required value of instant vehicle speed, at least in part by controlling an amount of powertrain torque applied to one or more wheels of a vehicle by a powertrain;

causing a change in instant vehicle speed according to a predetermined speed profile by causing a corresponding change in instant target speed parameter; and

determining when a powertrain torque interruption occurs,

the method comprising substantially suspending causing the change in instant target speed parameter according to the predetermined speed profile when a powertrain torque interruption occurs.

Some embodiments of the present invention may provide a speed control system for a vehicle, comprising means for causing automatically a vehicle to travel at a required speed value at least in part by controlling an amount of torque applied to one or more wheels of a vehicle by a powertrain. The system may have means for causing automatically a change in the required speed value according to a predetermined speed profile thereby to cause a corresponding change in an instant speed of a vehicle. The system may have means for determining automatically when a powertrain torque interruption occurs. The system may be configured automatically substantially to suspend causing the change in required speed value according to the predetermined speed profile when a powertrain torque interruption occurs.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software to be executed on said computational device. A controller may be implemented in software run on one or more processors. Other suitable arrangements may also be used.

Within the scope of this application it is envisaged that the various aspects, embodiments, examples and alternatives, and in particular the individual features thereof, set out in the preceding paragraphs, in the claims and/or in the following description and drawings, may be taken independently or in any combination. For example features described in connection with one embodiment are applicable to all embodiments, unless such features are incompatible.

For the avoidance of doubt, it is to be understood that features described with respect to one aspect of the invention may be included within any other aspect of the invention, alone or in appropriate combination with one or more other features.

### BRIEF DESCRIPTION OF THE DRAWINGS

One or more embodiments of the invention will now be described, by way of example only, with reference to the accompanying figures in which:

FIG. 1 is a schematic illustration of a vehicle according to an embodiment of the invention in plan view;

FIG. 2 shows the vehicle of FIG. 1 in side view;

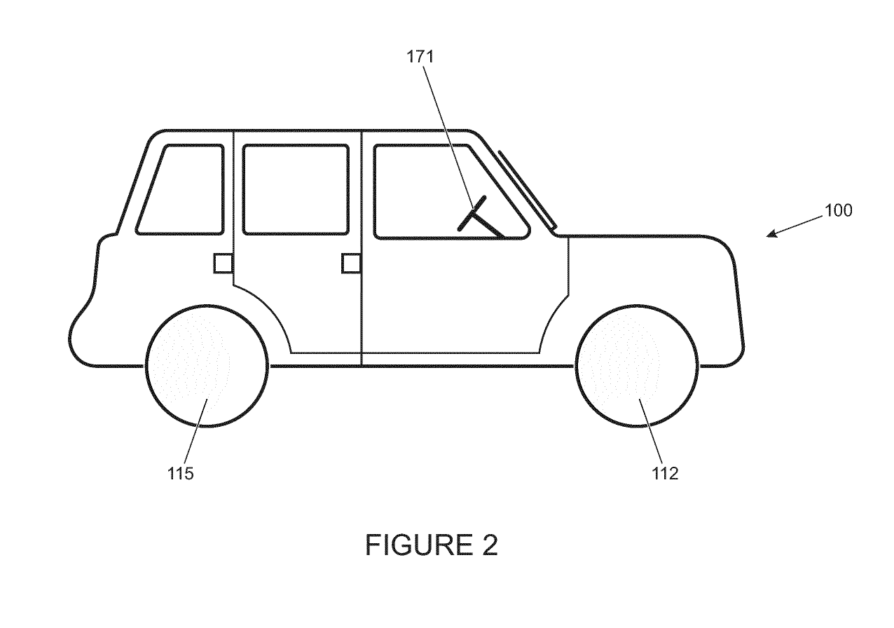

FIG. 3 is a high level schematic diagram of a speed control system of the vehicle of FIG. 1, including a cruise control system and a low-speed progress control system;

FIG. 4 illustrates a steering wheel and brake and accelerator pedals of the vehicle of FIG. 1;

FIG. 5 is a schematic illustration of a portion of the control system of the vehicle of FIG. 1;

FIG. 6 shows (a) a predetermined speed profile for use when an increase in vehicle speed is required and (b) a corresponding predetermined speed profile for use when a decrease in vehicle speed is required;

FIG. 7 is a schematic illustration of a portion of the control system of the vehicle of FIG. 1; and

FIG. 8 is a schematic illustration of a portion of a control system of the vehicle of FIG. 1.

### DETAILED DESCRIPTION

References herein to a block such as a function block are to be understood to include reference to items of vehicle hardware, such as electronic modules, and to software code for performing the function or action specified which may be an output that is provided responsive to one or more inputs. The code may be in the form of a software routine or function called by a main computer program, or may be code forming part of a flow of code not being a separate routine or function. Reference to function block is made for ease of explanation of the manner of operation of embodiments of the present invention.

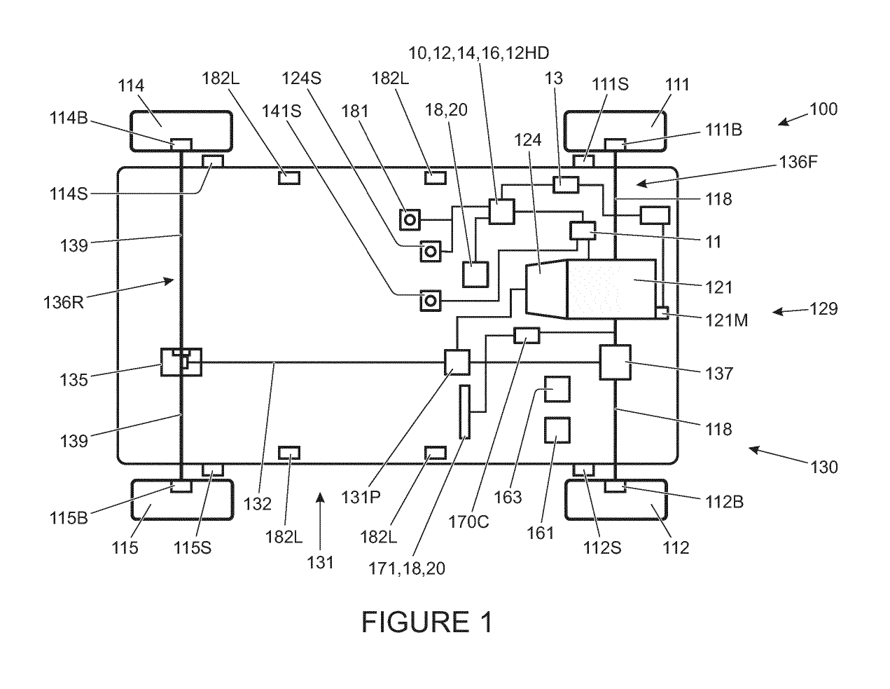

FIG. 1 shows a vehicle 100 according to an embodiment of the present invention. The vehicle 100 has a powertrain 129 that includes an engine 121 that is connected to a driveline 130 having an automatic transmission 124. It is to be understood that embodiments of the present invention are also suitable for use in vehicles with manual transmissions, continuously variable transmissions or any other suitable transmission.

In the embodiment of FIG. 1 the transmission 124 may be set to one of a plurality of transmission operating modes, being a park mode P, a reverse mode R, a neutral mode N, a drive mode D or a sport mode S, by means of a transmission mode selector dial 124S. The selector dial 124S provides an output signal to a powertrain controller 11 in response to which the powertrain controller 11 causes the transmission 124 to operate in accordance with the selected transmission mode.

The driveline 130 is arranged to drive a pair of front vehicle wheels 111,112 by means of a front differential 137 and a pair of front drive shafts 118. The driveline 130 also comprises an auxiliary driveline portion 131 arranged to drive a pair of rear wheels 114, 115 by means of an auxiliary driveshaft or prop-shaft 132, a rear differential 135 and a pair of rear driveshafts 139. The front wheels 111, 112 in combination with the front drive shafts 118 and front differential 137 may be referred to as a front axle 136F. The rear wheels 114, 115 in combination with rear drive shafts 139 and rear differential 135 may be referred to as a rear axle 136R.

The wheels 111, 112, 114, 115 each have a respective brake 111B, 112B, 114B, 115B. Respective speed sensors 111S, 112S, 114S, 115S are associated with each wheel 111, 112, 114, 115 of the vehicle 100. The sensors 111S, 112S, 114S, 115S are mounted to a body 100B of the vehicle 100 and arranged to measure a speed of the corresponding wheel.

Embodiments of the invention are suitable for use with vehicles in which the transmission is arranged to drive only a pair of front wheels or only a pair of rear wheels (i.e. front wheel drive vehicles or rear wheel drive vehicles) or selectable two wheel drive/four wheel drive vehicles. In the embodiment of FIG. 1 the transmission 124 is releasably connectable to the auxiliary driveline portion 131 by means of a power transfer unit (PTU) 131P, allowing operation in a two wheel drive mode or a four wheel drive mode. It is to be understood that embodiments of the invention may be suitable for vehicles having more than four wheels or where only two wheels are driven, for example two wheels of a three wheeled vehicle or four wheeled vehicle or a vehicle with more than four wheels.

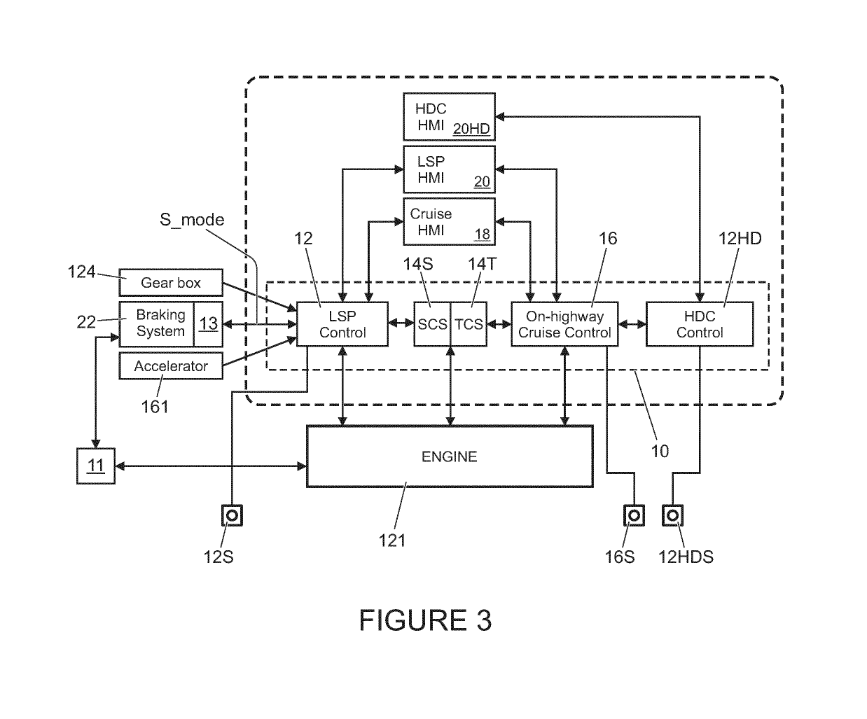

A control system for the vehicle 100 includes a central controller 10, referred to as a vehicle control unit (VCU) 10, the powertrain controller 11, a brake controller 13 and a steering controller 170C. The brake controller 13 is an anti-lock braking system (ABS) controller 13 and forms part of a braking system 22 (FIG. 3). The VCU 10 receives and outputs a plurality of signals to and from various sensors and subsystems (not shown) provided on the vehicle. The VCU 10 includes a low-speed progress (LSP) control system 12 shown in FIG. 3, a stability control system (SCS) 14S, a traction control system (TCS) 14T, a cruise control system 16 and a Hill Descent Control (HDC) system 12HD. The SCS 14S improves stability of the vehicle 100 by detecting and managing loss of traction when cornering. When a reduction in steering control is detected, the SCS 14S is configured automatically to command a brake controller 13 to apply one or more brakes 111B, 112B, 114B, 115B of the vehicle 100 to help to steer the vehicle 100 in the direction the user wishes to travel. If excessive wheel spin is detected, the TCS 14S is configured to reduce wheel spin by application of brake force in combination with a reduction in powertrain drive torque. In the embodiment shown the SCS 14S and TCS 14T are implemented by the VCU 10. In some alternative embodiments the SCS 14S and/or TCS 14T may be implemented by the brake controller 13. Further alternatively, the SCS 14S and/or TCS 14T may be implemented by one or more further controllers.

Similarly, one or more of the controllers 10, 11, 13, 170C may be implemented in software run on a respective one or more computing devices such as one or more electronic control units (ECUs). In some embodiments two or more of the controllers 10, 11, 13, 170C may be implemented in software run on one or more common computing devices. Two or more controllers 10, 11, 13, 170C may be implemented in software in the form of a combined software module.

It is to be understood that one or more computing devices may be configured to permit a plurality of software modules to be run on the same computing device without interference between the modules. For example the computing devices may be configured to allow the modules to run such that if execution of software code embodying a first controller terminates erroneously, or the computing device enters an unintended endless loop in respect of one of the modules, it does not affect execution of software code comprised by a software module embodying a second controller.

It is to be understood that one or more of the controllers 10, 11, 13, 170C may be configured to have substantially no single point failure modes, i.e. one or more of the controllers may have dual or multiple redundancy. It is to be understood that robust partitioning technologies are known for enabling redundancy to be introduced, such as technologies enabling isolation of software modules being executed on a common computing device. It is to be understood that the common computing device will typically comprise at least one microprocessor, optionally a plurality of processors, which may operate in parallel with one another. In some embodiments a monitor may be provided, the monitor being optionally implemented in software code and configured to raise an alert in the event a software module is determined to have malfunctioned.

The SCS 14S, TCS 14T, ABS controller 22C and HDC system 12HD provide outputs indicative of, for example, SCS activity, TCS activity and ABS activity including brake interventions on individual wheels and engine torque requests from the VCU 10 to the engine 121, for example in the event a wheel slip event occurs. Each of the aforementioned events indicate that a wheel slip event has occurred. Other vehicle sub-systems such as a roll stability control system or the like may also be present.

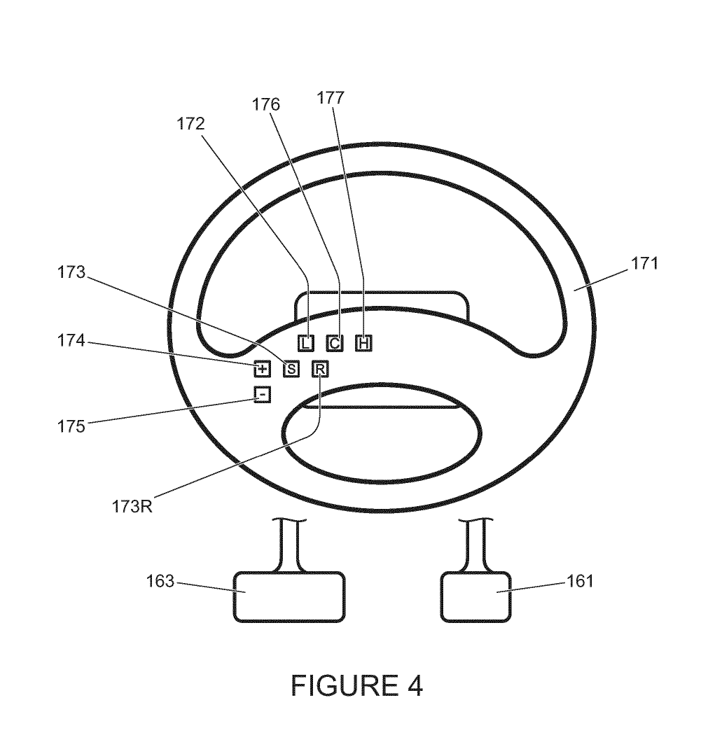

As noted above the vehicle 100 includes a cruise control system 16 which is operable to automatically maintain vehicle speed at a selected speed when the vehicle is travelling at speeds in excess of 25 kph. The cruise control system 16 is provided with a cruise control HMI (human machine interface) 18 by which means the user can input a target vehicle speed to the cruise control system 16 in a known manner. In one embodiment of the invention, cruise control system input controls are mounted to a steering wheel 171 (FIG. 4). The cruise control system 16 may be switched on by pressing a cruise control system selector button 176. When the cruise control system 16 is switched on, depression of a ‘set-speed’ control 173 sets the current value of a cruise control set-speed parameter, cruise_set-speed to the current vehicle speed. Depression of a ‘+’ button 174 allows the value of cruise_set-speed to be increased while depression of a ‘−’ button 175 allows the value of cruise_set-speed to be decreased. A resume button 173R is provided that is operable to control the cruise control system 16 to resume speed control at the instant value of cruise_set-speed following a driver over-ride intervention. It is to be understood that known on-highway cruise control systems including the present system 16 are configured so that, in the event that the user depresses the brake or, in the case of vehicles with a manual transmission, a clutch pedal, the cruise control function is cancelled and the vehicle 100 reverts to a manual mode of operation which requires accelerator pedal input by a user in order to maintain vehicle speed. In addition, detection of a wheel slip event, as may be initiated by a loss of traction, also has the effect of cancelling the cruise control function. Speed control by the system 16 is resumed if the driver subsequently depresses the resume button 173R.

The cruise control system 16 monitors vehicle speed and any deviation from the target vehicle speed is adjusted automatically so that the vehicle speed is maintained at a substantially constant value, typically in excess of 25 kph. In other words, the cruise control system is ineffective at speeds lower than 25 kph. The cruise control HMI 18 may also be configured to provide an alert to the user about the status of the cruise control system 16 via a visual display of the HMI 18. In the present embodiment the cruise control system 16 is configured to allow the value of cruise_set-speed to be set to any value in the range 25-150 kph.

The LSP control system 12 also provides a speed-based control system for the user, which enables the user to select a very low target speed at which the vehicle can progress without any pedal inputs being required by the user. Low-speed speed control (or progress control) functionality is not provided by the on-highway cruise control system 16 which operates only at speeds above 25 kph.

The LSP control system 12 is activated by means of a LSP control system selector button 172 mounted on the steering wheel 171. The system 12 is operable to apply selective powertrain, traction control and braking actions to one or more wheels of the vehicle 100, collectively or individually, to maintain the vehicle 100 at the desired speed. It is to be understood that in some embodiments the LSP control system selector button 172 may be mounted in a location other than on the steering wheel 171, such as in a dashboard or any other suitable location.

The LSP control system 12 is configured to allow a user to input a desired value of set-speed parameter, user_set-speed to the LSP control system 12 via a low-speed progress control HMI (LSP HMI) 20 (FIG. 1, FIG. 3) which shares certain input buttons 173-175 with the cruise control system 16 and HDC control system 12HD. Provided the vehicle speed is within the allowable range of operation of the LSP control system (which is the range from 2 to 30 kph in the present embodiment although other ranges are also useful) the LSP control system 12 controls vehicle speed in accordance with the value of user_set-speed by setting a parameter LSP_set-speed equal to the value of user_set-speed. In some embodiments, the system 12 may be configured to determine whether a lower value of LSP_set-speed is more appropriate as discussed in more detail below. Unlike the cruise control system 16, the LSP control system 12 is configured to operate independently of the occurrence of a traction event. That is, the LSP control system 12 does not cancel speed control upon detection of wheel slip. Rather, the LSP control system 12 actively manages vehicle behaviour when slip is detected.

The LSP control HMI 20 is provided in the vehicle cabin so as to be readily accessible to the user. The user of the vehicle 100 is able to input to the LSP control system 12, via the LSP HMI 20, an indication of the speed at which the user desires the vehicle to travel, user_set-speed, by means of the ‘set-speed’ button 173 and the ‘+’/‘−’ buttons 174, 175 in a similar manner to the cruise control system 16. The LSP HMI 20 also includes a visual display upon which information and guidance can be provided to the user about the status of the LSP control system 12.

The LSP control system 12 receives an input from the braking system 22 of the vehicle indicative of the extent to which the user has applied braking by means of the brake pedal 163. The LSP control system 12 also receives an input from an accelerator pedal 161 indicative of the extent to which the user has depressed the accelerator pedal 161. An input is also provided to the LSP control system 12 from the transmission or gearbox 124. This input may include signals representative of, for example, the speed of an output shaft of the gearbox 124, torque converter slip and a gear ratio request. Other inputs to the LSP control system 12 include an input from the cruise control HMI 18 which is representative of the status (ON/OFF) of the cruise control system 16, and an input from the LSP control HMI 20.

The HDC system 12HD is configured to limit vehicle speed when descending a gradient. When the HDC system 12HD is active, the system 12HD controls the braking system 22 (via brake controller 13) in order to limit vehicle speed to a value corresponding to that of a HDC set-speed parameter HDC_set-speed which may be set by a user. The HDC set-speed may also be referred to as an HDC target speed. Provided the user does not override the HDC system by depressing the accelerator pedal when the HDC system 12HD is active, the HDC system 12HD controls the braking system 22 to prevent vehicle speed from exceeding the value of HDC_set-speed. In the present embodiment the HDC system 12HD is not operable to apply positive drive torque. Rather, the HDC system 12HD is only operable to apply negative brake torque by means of the braking system 22.

A HDC system HMI 20HD is provided by means of which a user may control the HDC system 12HD, including setting the value of HDC_set-speed. An HDC system selector button 177 is provided on the steering wheel 171 by means of which a user may activate the HDC system 12HD to control vehicle speed.

As noted above, the HDC system 12HD is operable to allow a user to set a value of HDC set-speed parameter HDC_set-speed and to adjust the value of HDC_set-speed using the same controls as the cruise control system 16 and LSP control system 12. Thus, in the present embodiment, when the HDC system 12HD is controlling vehicle speed, the HDC system set-speed may be increased, decreased or set to an instant speed of the vehicle in a similar manner to the set-speed of the cruise control system 16 and LSP control system 12, using the same control buttons 173, 173R, 174, 175. The HDC system 12HD is operable to allow the value of HDC_set-speed to be set to any value in the range from 2-30 kph.

If the HDC system 12HD is selected when the vehicle 100 is travelling at a speed of 50 kph or less and no other speed control system is in operation, the HDC system 12HD sets the value of HDC_set-speed to a value selected from a look-up table. The value output by the look-up table is determined in dependence on the identity of the currently selected transmission gear, the currently selected PTU gear ratio (Hi/LO) and the currently selected driving mode. The HDC system 12HD then applies the powertrain 129 and/or braking system 22 to slow the vehicle 100 to the HDC system set-speed provided the driver does not override the HDC system 12HD by depressing the accelerator pedal 161. The HDC system 12HD is configured to slow the vehicle 100 to the set-speed value at a deceleration rate not exceeding a maximum allowable rate although as noted elsewhere the HDC system 12HD is not able to cause positive drive torque to be applied by the powertrain 129 in order to reduce a rate of deceleration of the vehicle 100. The maximum allowable rate of deceleration is set at 1.25 ms-2 in the present embodiment, however other values may be useful in some embodiments. If the user subsequently presses the ‘set-speed’ button 173 the HDC system 12HD sets the value of HDC_set-speed to the instant vehicle speed provided the instant speed is 30 kph or less. If the HDC system 12HD is selected when the vehicle 100 is travelling at a speed exceeding 50 kph, the HDC system 12HD ignores the request and provides an indication to the user that the request has been ignored.

It is to be understood that the VCU 10 is configured to implement a known Terrain Response (TR)® System of the kind described above in which the VCU 10 controls settings of one or more vehicle systems or sub-systems such as the powertrain controller 11 in dependence on a selected driving mode. The driving mode may be selected by a user by means of a driving mode selector 141S (FIG. 1). The driving modes may also be referred to as terrain modes, terrain response modes, or control modes. In the embodiment of FIG. 1 four driving modes are provided: an ‘on-highway’ driving mode or ‘special programs off’ (SPO) mode suitable for driving on a relatively hard, smooth driving surface where a relatively high surface coefficient of friction exists between the driving surface and wheels of the vehicle; a ‘sand’ driving mode (SAND) suitable for driving over sandy terrain; a ‘grass, gravel or snow’ (GGS) driving mode suitable for driving over grass, gravel or snow, a ‘rock crawl’ (RC) driving mode suitable for driving slowly over a rocky surface; and a ‘mud and ruts’ (MR) driving mode suitable for driving in muddy, rutted terrain. Other driving modes may be provided in addition or instead.

In the present embodiment, at any given moment in time the LSP control system 12 is in one of a plurality of allowable ‘on’ modes (also referred to as conditions or states) selected from amongst an active or full function (FF) mode, a descent control (DC) mode, also referred to as an intermediate mode and a standby mode. The LSP control system may also assume an ‘off’ mode or condition. The active mode, DC mode and standby mode may be considered to be different ‘on’ modes or conditions of the vehicle, i.e. different modes in which the LSP control system is in an ‘on’ mode or condition as opposed to an ‘off’ mode or condition. In the off condition the LSP control system 12 only responds to pressing of the LSP selector button 172, which causes the LSP control system 12 to assume the on condition and the DC mode. When the LSP control system 12 assumes the on mode from the off mode in response to pressing of the LSP selector button, the value of user_set-speed is set to the instant speed of the vehicle 100 provided it is in the allowable range of speeds for operation of the LSP control system 12. If the vehicle speed 100 is above the allowable range of speeds for operation of the LSP control system 12, the value of user_set-speed is set to the highest allowable speed for operation of the LSP control system 12, i.e. 30 kph. The system 12 then sets the value of LSP_set-speed equal to user_set-speed.

In the active or full function mode, the LSP control system 12 actively manages vehicle speed in accordance with the value of LSP_set-speed, by causing the application of positive powertrain drive torque to one or more driving wheels or negative braking system torque to one or more braked wheels.

In the DC mode the LSP control system 12 operates in a similar manner to that in which it operates when in the active mode except that the LSP control system 12 is prevented from commanding the application of positive drive torque by means of the powertrain 129. Rather, only braking torque may be applied, by means of the braking system 22 and/or powertrain 129. The LSP control system 12 is configured to increase or decrease the amount of brake torque applied to one or more wheels in order to cause the vehicle to maintain a speed substantially equal to LSP_set-speed to the extent possible without application of positive drive torque. It is to be understood that, in the present embodiment, operation of the LSP control system 12 in the DC mode is very similar to operation of the HDC system 12HD, except that the LSP control system 12 continues to employ the LSP control system 12 set-speed value LSP_set-speed rather than the HDC control system set-speed value HDC_set-speed.

In the standby mode, the LSP control system 12 is unable to cause application of positive drive torque or negative brake torque to a wheel.

As noted above, in the ‘off’ mode the LSP control system 12 is not responsive to any LSP input controls except the LSP control system selector button 172. Pressing of the LSP control system selector button 172 when the system 12 is in the off mode causes the system 12 to assume the ‘on’ condition and the DC mode.

When the LSP control system 12 is initially switched on by means of the LSP selector button 172, the LSP control system 12 assumes the DC mode.

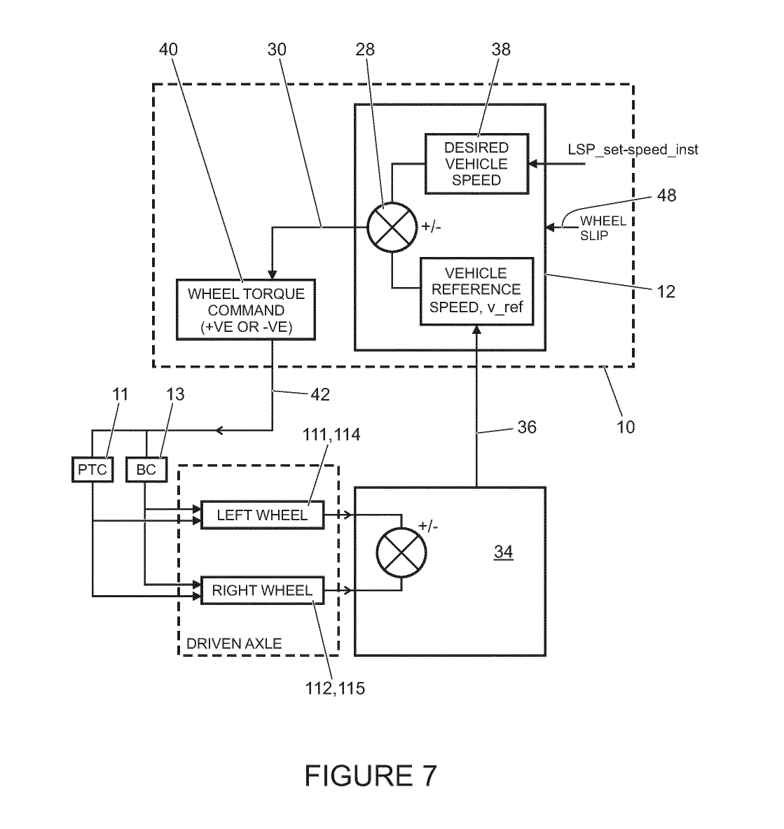

If while in DC mode the ‘set +’ button 174 is pressed, the LSP control system 12 sets the value of user_set-speed to the instant value of vehicle speed according to vehicle speed signal 36 (FIG. 7, discussed in more detail below) and assumes the active mode. If the vehicle speed is above 30 kph, being the maximum allowable value of user_set-speed and LSP_set-speed, the LSP control system 12 remains in the DC mode and ignores the request to assume the active mode. A signal may be provided to the driver indicating that the LSP control system 12 cannot be activated due to the vehicle speed exceeding the maximum allowable value of LSP_set-speed. The signal may be provided by means of a text message provided on the LSP control HMI 18, by means of an indicator lamp, an audible alert or any other suitable means.

If the resume button 173R is depressed while in the DC mode, the LSP control system assumes the active mode and causes the vehicle to operate in accordance with the stored value of user_set-speed, i.e. LSP_set-speed is set to the stored value of user_set-speed, provided the vehicle speed does not exceed 30 kph.

If vehicle speed is above 30 kph but less than or substantially equal to 50 kph when the resume button 173R is pressed the LSP control system 12 remains in the DC mode until vehicle speed falls below 30 kph. In the DC mode, provided the driver does not depress the accelerator pedal 161 the LSP control system 12 deploys the braking system 22 to slow the vehicle 100 to a speed substantially equal to the value of parameter LSP_set-speed. Once the vehicle speed falls to 30 kph or below, the LSP control system 12 assumes the active mode in which it is operable to cause a required amount of positive powertrain drive torque to be applied to one or more wheels via the powertrain 129, as well as negative torque via the powertrain 129 (via engine braking) and brake torque via the braking system 22 in order to control the vehicle in accordance with the LSP_set-speed value. The LSP control system 12 may generate a virtual accelerator pedal signal in order to cause the powertrain 129 to develop a required amount of powertrain torque in some embodiments. The virtual accelerator pedal signal may correspond to that which would be generated by an accelerator pedal controller in response to depression of the accelerator pedal 161 by an amount corresponding to the amount of powertrain torque required at a given moment in time. The accelerator pedal controller may form part of a powertrain controller 11 although other arrangements are also useful.

With the LSP control system 12 in the active mode, the user may increase or decrease the value of user_set-speed by means of the ‘+’ and ‘−’ buttons 174, 175. In addition, the user may optionally also increase or decrease the value of user_set-speed by lightly pressing the accelerator or brake pedals 161, 163 respectively. In some embodiments, with the LSP control system 12 in the active mode the ‘+’ and ‘−’ buttons 174, 175 may be disabled such that adjustment of the value of user_set-speed can only be made by means of the accelerator and brake pedals 161, 163. This latter feature may prevent unintentional changes in set-speed from occurring, for example due to accidental pressing of one of the ‘+’ or ‘−’ buttons 174, 175. Accidental pressing may occur for example when negotiating difficult terrain where relatively large and frequent changes in steering angle may be required. Other arrangements are also useful.

It is to be understood that in the present embodiment the LSP control system 12 is operable to cause the vehicle to travel in accordance with a value of LSP_set-speed in the range from 2-30 kph while the cruise control system is operable to cause the vehicle to travel in accordance with a value of set-speed in the range from 25-150 kph although other values are also useful, such as 30-120 kph or any other suitable range of values.

It is to be understood that if the LSP control system 12 is in the active mode, operation of the cruise control system 16 is inhibited. The two speed control systems 12, 16 therefore operate independently of one another, so that only one can be operable at any one time.

In some embodiments, the cruise control HMI 18 and the LSP control HMI 20 may be configured within the same hardware so that, for example, the speed selection is input via the same hardware, with one or more separate switches being provided to switch between the LSP control HMI 20 and the cruise control HMI 18.

When in the active mode, the LSP control system 12 is configured to command application of positive powertrain torque and negative brake torque, as required, by transmitting a request for (positive) drive torque in the form of a powertrain torque signal and/or a request for (negative) brake torque in the form of a brake torque signal to the brake controller 13. The brake controller 13 arbitrates any demand for positive powertrain torque, determining whether the request for positive powertrain torque is allowable. If a request for positive powertrain torque is allowable the brake controller 13 issues the request to the powertrain controller 11. In some embodiments, the request for brake torque may correspond to an amount of brake torque (or brake fluid pressure) to be developed by the braking system 22. In some alternative embodiments the request for brake torque may be for an amount of negative torque to be applied to one or more wheels. The brake controller 13 may in some embodiments determine whether the requested negative torque is to be supplied by means of powertrain braking alone, for example engine overrun braking, by means of powertrain braking and brake torque developed by the braking system 22, or by means of the braking system 22 alone. In some embodiments the brake controller 13 or LSP control system 12 may be configured to cause a required amount of net negative torque to be applied to one or more wheels by applying negative torque by means of the braking system 22 against positive drive torque generated by the powertrain 129. Application of positive drive torque generated by means of the powertrain 129 against negative brake torque generated by means of the braking system 22 may be made in order to reduce wheel flare when driving on surfaces of relatively low surface coefficient of friction such as during off-road driving. By wheel flare is meant excessive wheel slip as a result of the application of excess positive net torque to a wheel.

The sensors on the vehicle 100 include sensors which provide continuous sensor outputs to the VCU 10, including wheel speed sensors, as mentioned previously and as shown in FIG. 1, and other sensors (not shown) such as an ambient temperature sensor, an atmospheric pressure sensor, tire pressure sensors, wheel articulation sensors, gyroscopic sensors to detect vehicular yaw, roll and pitch angle and rate, a vehicle speed sensor, a longitudinal acceleration sensor, an engine torque sensor (or engine torque estimator), a steering angle sensor, a steering wheel speed sensor, a gradient sensor (or gradient estimator), a lateral acceleration sensor which may be part of the SCS 14S, a brake pedal position sensor, a brake pressure sensor, an accelerator pedal position sensor, longitudinal, lateral and vertical motion sensors, and water detection sensors forming part of a vehicle wading assistance system (not shown). In other embodiments, only a selection of the aforementioned sensors may be used. Other sensors may be useful in addition or instead in some embodiments.

The VCU 10 also receives a signal from the steering controller 170C. The steering controller 170C is in the form of an electronic power assisted steering unit (ePAS unit). The steering controller 170C provides a signal to the VCU 10 indicative of the steering force being applied to steerable road wheels 111, 112 of the vehicle 100. This force corresponds to that applied by a user to the steering wheel 171 in combination with steering force generated by the ePAS unit 170C.

The VCU 10 evaluates the various sensor inputs to determine the probability that each of a plurality of different control modes (driving modes) for the vehicle subsystems is appropriate, with each control mode corresponding to a particular terrain type over which the vehicle is travelling (for example, mud and ruts, sand, grass/gravel/snow).

If the user has selected operation of the vehicle in an automatic driving mode selection condition, the VCU 10 then selects the most appropriate one of the control modes and is configured automatically to control the subsystems according to the selected mode. This aspect of the invention is described in further detail in our co-pending patent application nos. GB2492748, GB2492655 and GB2499252, the contents of each of which is incorporated herein by reference.

In some embodiments, the nature of the terrain over which the vehicle is travelling (as determined by reference to the selected control mode) may be utilized by the LSP control system 12 to determine an appropriate increase or decrease in vehicle speed. For example, if the user selects a value of user_set-speed that is not suitable for the nature of the terrain over which the vehicle is travelling, the system 12 may in some embodiments automatically adjust the vehicle speed downwards by reducing the value of LSP_set-speed. In some cases, for example, the user selected speed may not be achievable or appropriate over certain terrain types, particularly in the case of uneven or rough surfaces. If the system 12 selects automatically a value of LSP_set-speed that differs from the value of user_set-speed, a visual indication of the speed constraint may be provided to the user via the LSP HMI 20 to indicate that an alternative speed has been adopted.

In the present embodiment, the LSP control system 12 is configured to determine the speed at which the vehicle 100 is to be required to operate, LSP_set-speed, according to the value of user_set-speed input by a user.

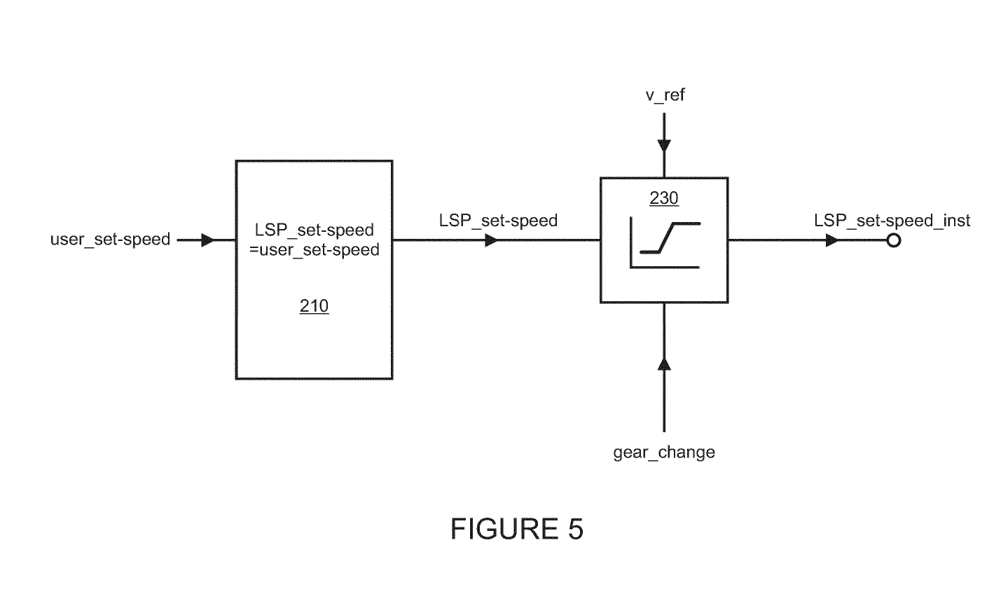

As illustrated in FIG. 5, the value of user_set-speed is input to function block 210. Function block 210 sets the value of the prevailing target speed of the LSP control system 12, LSP_set-speed, equal to the value of user_set-speed and outputs the value of LSP_set-speed to a rate limiter function block 230. Rate limiter function block 230 also receives as an input a signal gear_change that is set to logic ‘1’ whenever a powertrain torque interruption occurs due to the transmission 124 undertaking a gear change and logic ‘0’ at all other times, and a vehicle reference speed signal v_ref indicative of the instant vehicle speed.

The rate limiter function block 230 is configured to output a signal LSP_set-speed_inst in dependence on the value of LSP_set-speed, gear_change and v_ref. The rate limiter function block 230 outputs the value of parameter LSP_set-speed_inst to a portion of the LSP control system 12 responsible for direct control of vehicle speed. This portion of the powertrain is configured substantially continuously to attempt to maintain vehicle reference speed v_ref substantially equal to LSP_set-speed_inst as described below with reference to FIG. 7.

The rate limiter function block 230 attempts to cause v_ref to become equal to LSP_set-speed by adjusting LSP_set-speed_inst at a rate determined according to a predetermined acceleration profile stored by the LSP control system 12. The rate limiter function block 230 causes the value of LSP_set-speed_inst (and in turn v_ref) to transition iteratively towards the value of LSP_set-speed at a rate determined according to the predetermined acceleration profile.

As noted above, the rate limiter function block 230 stores an acceleration profile that is employed when v_ref is less than LSP_set-speed and an increase in v_ref is required and may optionally also store an acceleration profile employed when v_ref is greater than LSP_set-speed and a decrease in v_ref is required. This is because in certain terrain conditions it is desirable to have positive acceleration profiles that demand higher rates of acceleration than the corresponding negative acceleration profiles, and vice-versa. However it will be appreciated that a common profile may be used for both acceleration and deceleration in some embodiments.

In some embodiments, the predetermined acceleration profile employed is the same whether an increase or decrease in vehicle speed is required, the acceleration profile used when negative acceleration of the vehicle 100 is required, i.e. when deceleration is required, being the inverse (negative) of that used when positive acceleration of the vehicle 100 is required. However in some alternative embodiments, the system 12 may employ a different acceleration profile for positive acceleration compared with that for negative acceleration.

In some embodiments the controller 11 may store a plurality of acceleration profiles corresponding to positive values of vehicle acceleration (employed when v_ref is less than LSP_set-speed and an increase in v_ref is required) and/or a plurality of acceleration profiles corresponding to negative values of vehicle acceleration (employed when v_ref is greater than LSP_set-speed and a decrease in v_ref is required). This is because in certain terrain conditions such as when driving over sand, it may be desirable to have relative high acceleration profiles that demand higher rates of acceleration while in certain other terrain conditions it may be desirable to have positive acceleration profiles that demand lower rates of acceleration, such as when driving over grass, gravel or snow.

Selection from a plurality of positive and negative acceleration profiles is particularly advantageous. For example, when an increase in vehicle speed is required when driving on sandy terrain, it is typically desirable to accelerate at a relatively high rate of acceleration, while when a decrease in vehicle speed is required when driving on sandy terrain it is typically desirable to decelerate at a relatively low rate in order to reduce a risk of sink of one or more wheels into the driving surface. Sink of one or more wheels into the driving surface may result from skid associated with excessive braking on deformable surfaces such as sand. In contrast, when operating on surfaces such as grass, relatively low levels of acceleration and deceleration are desirable in order to reduce the extent to which the surface is modified as the vehicle progresses over the surface. Accordingly, in some embodiments, the LSP control system 12 is configured to take the nature of the terrain into account by selecting a suitable acceleration profile according to the selected driving mode. That is, the LSP control system 12 may select the predetermined acceleration profile in dependence at least in part on the selected driving mode. This may be accomplished in some embodiments by reference to a parameter indicative of driving mode, such as a parameter driving_mode. It will be appreciated that alternatively a single common profile may be used for acceleration and deceleration as in the present embodiment.

In the present embodiment, the predetermined acceleration profile is stored in a computer readable memory device associated with the LSP control system 12.

In some embodiments, the LSP control system 12 is configured to select the required acceleration profile from a plurality of profiles in dependence on whether an increase or decrease in vehicle speed is required, the system 12 employing a first profile where an increase in speed is required and a second profile where a decrease in vehicle speed is required. In some embodiments, the LSP control system 12 may employ a look-up table to determine the identity of the acceleration profile that is to be employed, for example in dependence on whether an increase or decrease in vehicle speed is required, and the identity of the currently selected driving mode. Other arrangements may also be useful.

The present applicant has recognized that if a powertrain torque interruption occurs while the rate limiter function block 230 is causing an increase in the value of LSP_set-speed_inst towards the prevailing value of LSP_set-speed, when v_ref is less than LSP_set-speed, a relatively rapid increase in vehicle acceleration may occur once the torque interruption has ceased and powertrain torque is restored, as the LSP control system 12 attempts to maintain the stored acceleration profile. This is because during the powertrain interruption the values of LSP_set speed_inst and v_ref will start to diverge due to the temporary interruption of the powertrain torque causing the vehicle to stop accelerating in line with the increase in LSP_set_speed_inst. When the powertrain torque is resumed after the interruption the discrepancy, which has developed between the value of LSP_set-speed_inst and the instantaneous vehicle speed v_ref during powertrain torque interruption, will cause the control system 12 to attempt to cause v_ref to catch up with the LSP_set-speed by demanding a torque increase in dependence on the difference. This will result in a surge in powertrain torque that exceeds the driver's expectation, i.e. the vehicle tries to quickly catch up to where it believes it should be on the acceleration profile.

The resulting loss of composure of the vehicle 100 as it quickly attempts to resume tracking the predetermined speed (acceleration) profile is undesirable. The applicant has recognized that this problem may be overcome by suspending increase in LSP_set-speed_{—}inst during the period of torque interruption, and resuming increases in LSP_set-speed_inst, according to the predetermined profile, once the torque interruption has ceased.

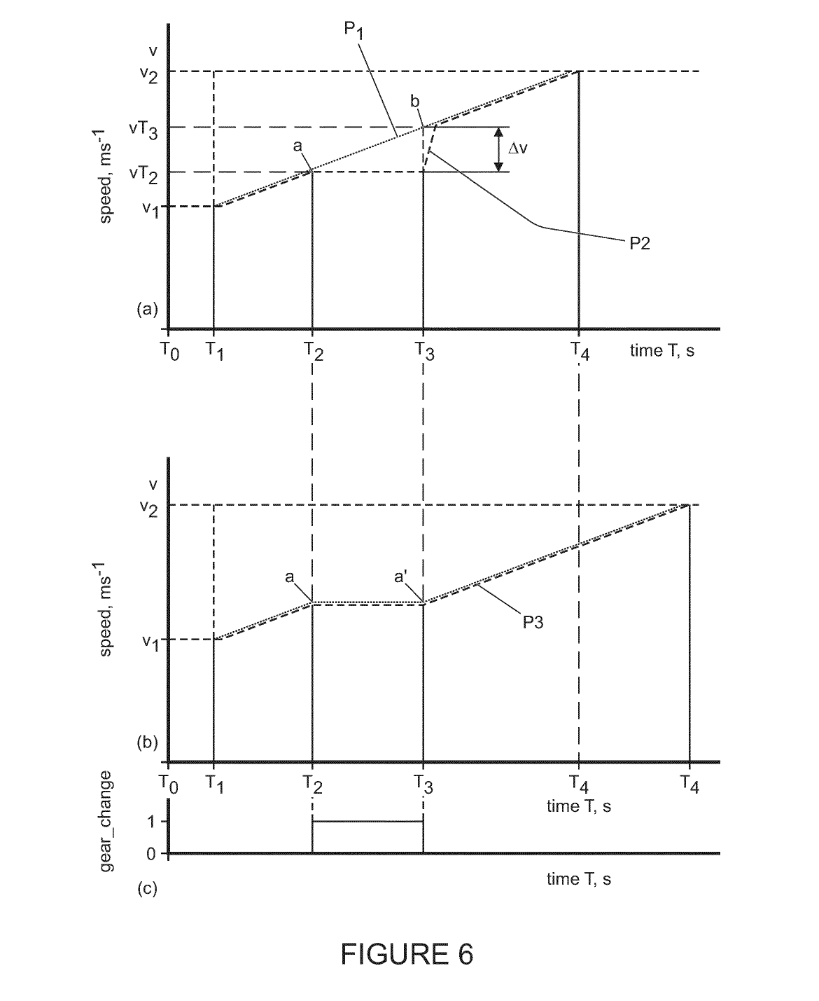

FIG. 6(a) illustrates schematically an example of an acceleration profile P1 stored by the rate limiter function block 230 for use when positive acceleration is required.

With reference to FIG. 6, in one example scenario illustrative of the manner of operation of some embodiments, at time T1 while the vehicle 100 is travelling at speed v1 a user_sets the value of user_set-speed to speed v2 where v2>v1, causing the LSP control system 12 to set the value of LSP_set-speed to v2 also. While the LSP control system 12 is causing acceleration of the vehicle 100 from speed v1 to a speed v2 according to the stored acceleration profile, the transmission 124 performs a gear shift operation from a lower gear to a higher gear at time T2 when vehicle speed is equal to v_{T2}. Signal gear_change assumes a value of ‘1’ during the period of the gear shift as illustrated in FIG. 6(c). The gear shift operation results in a temporary reduction in the amount of powertrain torque delivered to driving wheels of the vehicle until time T3, when the gear shift operation is complete. As shown by trace P2 in FIG. 6(a), vehicle speed remains substantially equal to v_{T2} during the period of torque interruption, i.e. the speed does not increase during this period.

It is to be understood that if the LSP control system 12 were to attempt to maintain vehicle speed at a given moment in time in accordance with the acceleration profile P1 shown in FIG. 6(a), the LSP control system 12 would attempt to compensate for the period of torque interruption by increasing the powertrain torque to accelerate of the vehicle 100 quickly towards the expected speed at point (b) of profile P1 after the period of torque interruption is complete, at time T3. This results in an acceleration at a rate that is higher than the rate that would otherwise have been assumed if the torque interruption had not occurred. This scenario is illustrated by profile P2 of FIG. 6(a). It is to be understood that this can result in a reduction in vehicle composure due to a relatively sharp increase in rate of acceleration once the period of torque interruption has expired.

In the present embodiment, the rate limiter function block 230 of the LSP control system 12 is configured to overcome this problem by suspending causing LSP_set-speed_inst to track the acceleration profile P1 when signal gear_change is set to logic ‘1’. That is, the rate limiter function block 210 effectively time-shifts the acceleration profile such that at time T3 the function block 210 resumes controlling vehicle speed as a function of time according to profile P1 starting at the position (a) of profile P1 substantially as illustrated in FIG. 6(a) at time T2 (or other location of the profile P1 corresponding to the current value of v_ref when the torque interruption terminates), rather than position (b) of the profile P1 illustrated in FIG. 6(a) at time T3. For a vehicle travelling uphill, or on a relatively flat or shallow downward sloping gradient, vehicle positive rate of acceleration will typically decrease during the period of torque interruption and may reduce substantially to zero or even become negative.

Once the period of torque interruption has ended, the LSP control system 12 is configured smoothly to accelerate the vehicle 100 to a rate of acceleration corresponding to that indicated by the profile P1 of FIG. 6(a) for the current (instant) value of v_ref in order to mitigate any reduction in vehicle composure. The LSP control system 12 then continues tracking the profile P1 from this position (a) of the profile P1.

The resulting acceleration profile is illustrated schematically by profile P3 of FIG. 6(b). It can be seen that substantially no increase in vehicle speed takes place during the period between T2 and T3, but that at point (a′) the system 12 resumes attempting to maintain a rate of increase of vehicle reference speed v_ref according to profile P1 after time T3 such that the vehicle rate of acceleration corresponds substantially to that illustrated by profile P1 time-shifted forward in time by a period of approximately Δt (‘delta t’) given by T3−T2.

In the present embodiment, the LSP control system 12 is configured to continue substantially continually to monitor vehicle reference speed v_ref when an increase in vehicle speed is being effected (i.e. when v_ref is less than LSP_set-speed). If vehicle speed increases to a value exceeding that prescribed by the acceleration profile P1, the system 12 adjusts the amount of powertrain torque delivered to one or more driving wheels and/or applies the braking system 22, in order to reduce the rate of increase of v_ref.

It is to be understood that a gear change may also take place when the LSP control system 12 is causing an increase in vehicle speed according to profile P1 while the vehicle 100 is descending an incline. A corresponding powertrain torque interruption therefore takes place, and the vehicle 100 may begin to accelerate at a higher rate than prescribed by the stored acceleration profile, for example due to a reduction in engine braking during the gear change. The LSP control system 12 will respond by causing application of the braking system 22 in order to maintain the predetermined acceleration profile. In such a case, suspension of tracking of the stored acceleration profile may not be required to be performed. In some embodiments, the rate limiter function block 230 may be able to monitor vehicle speed by reference to signal v_ref and determine whether it is necessary to suspend tracking of the stored acceleration profile in the manner described above, in dependence on whether the vehicle speed signal v_ref indicates that vehicle speed is falling relative to that prescribed by the vehicle speed profile during the period of torque interruption.

In some embodiments, if the LSP control system 12 is causing a reduction in LSP_set-speed_inst due to a reduction in LSP_set-speed, i.e. the LSP control system 12 is causing the vehicle 100 to decelerate, and the vehicle 100 is travelling uphill, the instant vehicle speed v_ref may drop below the value of LSP_set-speed_inst during the powertrain torque interruption if the hill is sufficiently steep. A surge of positive powertrain torque may then be commanded when the gear change is complete and the LSP control system 12 determines that v_ref is below the prevailing value of LSP_set-speed_inst. Accordingly, in some embodiments the LSP control system 12 is configured to suspend changes in LSP_set-speed_inst when signal gear_change indicates a gear change is in progress while the LSP control system 12 is causing the vehicle 100 to decelerate according to a predetermined profile, in order to counter this effect. When the period of powertrain torque interruption is over, the LSP control system 12 may resume causing the vehicle 100 to decelerate according to the predetermined profile by resuming tracking the profile at a rate of deceleration prescribed by the profile according to the instant vehicle speed v_ref. The LSP control system 12 takes into account the period of torque interruption and does not attempt to achieve the speed that would have been attained had the period of torque interruption not occurred.

In some embodiments, acceleration profiles employed by the LSP control system 12 are stored in the form of values of rate of acceleration as a function of speed. That is, a target value of vehicle acceleration may be set according to speed as the vehicle accelerates. In the case of launch from rest, when in the GGS driving mode for vehicle speeds of 0.7, 0.75, 1.5 and 5.0 m/s the corresponding target rates of acceleration may be 0.1, 0.05, 0.05 and 0.3 m/s² respectively in some embodiments. Other values may also be useful.

When launching from rest and operating in the Sand driving mode, for vehicle speeds of 0.7, 0.75, 1.0, 1.5 and 6.0 m/s the corresponding target rates of acceleration may be 0.4, 0.25, 0.25, 0.4 and 1.0 m/s² respectively. Other values may also be useful.

If the driver presses and holds the ‘set +’ button 174 while driving, causing an increase in the value of user_set-speed during the period for which the ‘set +’ button 174 is depressed, the rate of acceleration of the vehicle 100 may be governed by a maximum allowable rate of acceleration for each driving mode and a maximum allowable value of jerk. In the present embodiment, when the LSP control system 12 is in the GGS driving mode the maximum allowable rate of acceleration is 0.8 m/s² and the maximum allowable value of jerk is 1.0 m/s³. When the LSP control system 12 is in the Sand driving mode the maximum allowable rate of acceleration is 1.5 m/s² and the maximum allowable value of jerk is 1.0 m/s³. It is to be understood that other values may be useful in some embodiments.

As noted above, FIG. 7 illustrates schematically a portion of the LSP control system and vehicle 12 responsible for maintaining vehicle speed v_ref substantially equal to LSP_set-speed_inst.

As shown in FIG. 7, a vehicle speed calculator 34 provides a vehicle reference speed signal 36 (v_ref) indicative of vehicle speed to the LSP control system 12. The speed calculator 34 determines vehicle speed based on wheel speed signals provided by wheel speed sensors 111S, 112S, 114S, 115S, however it will be appreciated that other methods of determining vehicle speed may be used, for example direct speed over ground measurement, GPS etc. The LSP control system 12 includes a comparator 28 which compares the value of parameter LSP_set-speed_inst 38 (also referred to as an instant value of target speed 38) with the measured vehicle reference speed 36 and provides an output signal 30 indicative of the comparison. The output signal 30 is provided to an evaluator unit 40 of the VCU 10 which interprets the output signal 30 as either a demand for additional torque to be applied to the vehicle wheels 111-115, or for a reduction in torque applied to the vehicle wheels 111-115, depending on whether the vehicle speed needs to be increased or decreased to maintain a vehicle speed substantially equal to LSP_set-speed_inst. An increase in torque is generally accomplished by increasing the amount of powertrain torque delivered to a given position of the powertrain 129, for example an engine output shaft, a wheel or any other suitable location. A decrease in torque at a given wheel to a value that is less positive or more negative may be accomplished by decreasing the amount of any positive powertrain torque delivered to a wheel, by increasing the amount of any negative powertrain torque delivered to a wheel, for example by reducing an amount of air and/or fuel supplied to an engine 121, and/or by increasing a braking force on a wheel. It is to be understood that in some embodiments in which a powertrain 129 has one or more electric machines operable as a generator, negative torque may be applied by the powertrain 129 to one or more wheels by means of the electric machine. As noted above negative torque may also be applied by means of engine braking in some circumstances, depending at least in part on the speed at which the vehicle 100 is moving. If one or more electric machines are provided that are operable as propulsion motors, positive drive torque may be applied by means of the one or more electric machines.

An output 42 from the evaluator unit 40 is provided to the brake controller 13. The brake controller 13 in turn controls a net torque applied to the vehicle wheels 111-115 by commanding application of brake torque via the brakes 111B, 112B, 114B, 115B and/or positive or negative powertrain drive torque by commanding powertrain controller 11 to deliver a required amount of powertrain torque. The net torque may be increased or decreased depending on whether the evaluator unit 40 demands positive or negative torque. In some alternative embodiments a signal may be provided directly to the powertrain controller 11 from the evaluator unit 40, rather than via the brake controller 13 as in the present embodiment.

In order to cause application of the necessary positive or negative torque to the wheels, the brake controller 13 may command that positive or negative torque is applied to the vehicle wheels by the powertrain 129 and/or that a braking force is applied to the vehicle wheels by the braking system 22, either or both of which may be used to implement the change in torque that is necessary to attain and maintain a required vehicle speed. It is to be understood that the amount of the change (increase or decrease) in net torque will be dependent on the difference between actual vehicle speed and the required vehicle speed. In the illustrated embodiment the torque is applied to the vehicle wheels individually so as to maintain the vehicle 100 at the required speed, but in another embodiment torque may be applied to the wheels collectively to maintain the required speed. In some embodiments, the powertrain controller 11 may be operable to control an amount of torque applied to one or more wheels at least in part by controlling a driveline component such as a rear drive unit, front drive unit, differential or any other suitable component. For example, one or more components of the driveline 130 may include one or more clutches operable to allow an amount of torque applied to wheels of a given axle to be controlled independently of the torque applied to wheels of another axle, and/or the amount of torque applied to one or more individual wheels to be controlled independently of other wheels. Other arrangements are also useful.

Where a powertrain 129 includes one or more electric machines, for example one or more propulsion motors and/or generators, the powertrain controller 11 may be operable to modulate or control the amount of torque applied to one or more wheels at least in part by means of the one or more electric machines.

The LSP control system 12 also receives a signal 48 indicative of a wheel slip event having occurred. This may be the same signal 48 that is supplied to the on-highway cruise control system 16 of the vehicle, and which in the case of the latter triggers an override or inhibit mode of operation of the on-highway cruise control system 16 so that automatic control of vehicle speed by the on-highway cruise control system 16 is suspended or cancelled. However, the LSP control system 12 is not arranged to cancel or suspend operation in dependence on receipt of a wheel slip signal 48 indicative of wheel slip. Rather, the system 12 is arranged to monitor and subsequently manage wheel slip so as to reduce driver workload. During a slip event, the LSP control system 12 continues to compare the measured vehicle speed v_ref with the value of LSP_set-speed_inst, and continues to control automatically the torque applied to the vehicle wheels so as to maintain vehicle speed at the selected value. It is to be understood therefore that the LSP control system 12 is configured differently to the cruise control system 16, for which a wheel slip event has the effect of overriding the cruise control function so that manual operation of the vehicle 100 must be resumed, or speed control by the cruise control system 12 resumed by pressing the resume button 173R or set-speed button 173.

In a further embodiment of the present invention (not shown) a wheel slip signal 48 is derived not just from a comparison of wheel speeds, but further refined using sensor data indicative of the vehicle's speed over ground. Such a speed over ground determination may be made via global positioning (GPS) data, or via a vehicle mounted radar or laser based system arranged to determine the relative movement of the vehicle 100 and the ground over which it is travelling. A camera system may be employed for determining speed over ground in some embodiments.

At any stage of the LSP control process the user can override the LSP function by depressing the accelerator pedal 161 and/or brake pedal 163 to adjust the vehicle speed in a positive or negative sense. If the brake pedal 163 is depressed the LSP control system 12 terminates automatic control of vehicle speed, the extent to which the brake pedal needs to be depressed to cancel automatic speed control may depend on the presence of any other system that uses the brake pedal as an input, for example it may be necessary to depress the brake pedal beyond a certain limit to terminate automatic control of vehicle speed. However, absent any override by a user, in the event that a wheel slip event is detected via signal 48, the LSP control system 12 remains active and control of vehicle speed by the LSP control system 12 is not terminated. As shown in FIG. 7, this may be implemented by providing a wheel slip event signal 48 to the LSP control system 12 which is then managed by the LSP control system 12 and/or brake controller 13. In the embodiment shown in FIG. 1 the SCS 14S generates the wheel slip event signal 48 and supplies it to the LSP control system 12 and cruise control system 16.

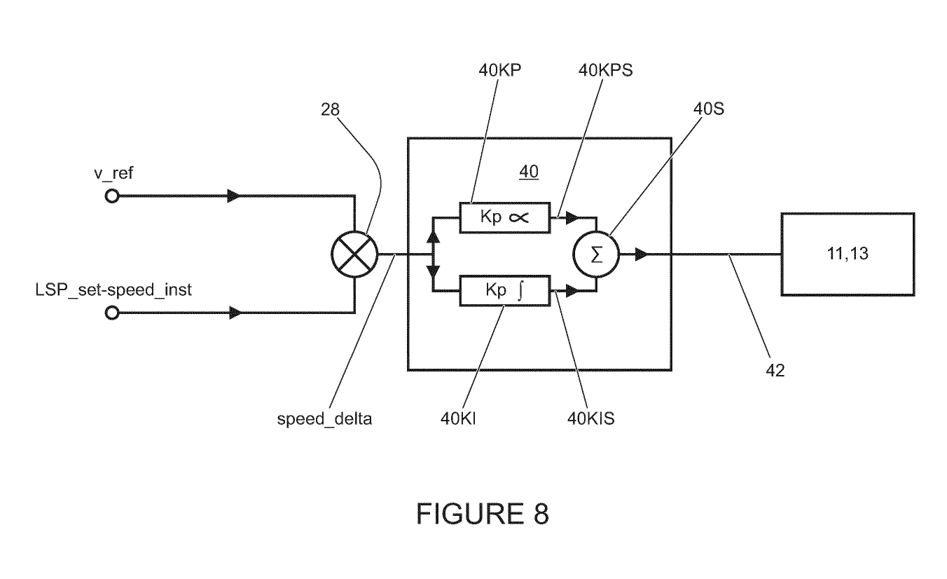

It is to be understood that in the present embodiment the LSP control system 12 employs a PI (proportional-integral) control methodology for controlling vehicle speed. FIG. 8 shows in more detail a portion of the LSP control system 12 illustrated in FIG. 3, including comparator 28 and evaluator unit 40.

The comparator 28 receives as inputs the values of signals v_ref and LSP_set-speed_inst, compares the values and outputs a signal speed_delta which is substantially equal to the difference between v_ref and LSP_set-speed_inst.

As shown in FIG. 8, the evaluator unit 40 includes a proportional element 40KP and an integral element 40KI. The proportional element 40KP outputs a signal 40KPS that is proportional to the value of parameter speed_delta, while the integral element 40KI outputs a signal 40KIS that is proportional to an integrated value over time of parameter speed_delta. Signals 40KPS and 40KIS are input to a summing element 40S that sums the signals 40KPS and 40KIS and outputs the sum as signal 42 to the brake controller 13.

In some embodiments, when the parameter gear_change is set to ‘1’, the LSP control system 12 freezes the values of signals 40KPS and 40KIS output by the proportional element 40KP and the integral element 40KI, respectively, until the parameter gear_change resumes a value of ‘0’. The LSP control system 12 additionally suspends tracking of the acceleration profile P1, P1′ during the period in which the parameter gear_change is set to ‘1’. Accordingly, when tracking of the acceleration profile P1, P1′ resumes, once the parameter gear_change reverts to a value of ‘0’, the evaluator unit 40 resumes operation in substantially the same state as when tracking of the acceleration profile P1, P1′ was suspended. This feature further enhances vehicle composure, and in turn user enjoyment of the vehicle 100.

It is to be understood that in some embodiments the LSP control system 12 may employ a different PI controller for controlling acceleration of a vehicle compared with deceleration of a vehicle.

It is to be understood that the LSP control system 12 may be configured to limit the rate of change of acceleration of the vehicle 100 both when a gear is commenced and when a gear change is complete. That is, jerk that may be experienced by a vehicle occupant when the vehicle transitions to the suspended mode and subsequently transitions out of the suspended mode may be limited. By jerk is meant a relatively high rate of change of acceleration of the vehicle 100, albeit momentarily, which may cause a temporary loss of vehicle composure. It is advantageous to limit the value of jerk so as to avoid loss of composure. In the present embodiment it is advantageous to limit jerk to a value of 1.0 m/s³.

Some embodiments of the present invention have the advantage that vehicle composure may be enhanced by suspending tracking of a predetermined acceleration profile (for positive and/or negative rates of acceleration) when a torque interruption takes place due to a gear shift. A surprising enhancement in passenger comfort and vehicle composure may be enjoyed.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A speed control system for automatically controlling the speed of a vehicle in accordance with a target speed value, the system comprising:
means for causing automatically a vehicle to travel at a required speed value at least in part by controlling an amount of torque applied to one or more wheels of a vehicle by a powertrain;
means for causing automatically a change in the required speed value according to a predetermined speed profile thereby to cause a corresponding change in a measured instant speed of a vehicle; and
means for determining automatically when a powertrain torque interruption occurs,
the system being configured temporarily to cause a suspension of changes in required speed value according to the predetermined speed profile when it is determined that a powertrain torque interruption occurs.

2. A system according to claim 1 wherein the means for causing automatically a vehicle to travel at a required speed value, and the means for causing a change in required speed value according to a predetermined speed profile, comprise an electric controller, the electric controller being configured to output a signal to cause a powertrain to apply a required amount of powertrain torque to one or more wheels of a vehicle.

3. A system according to claim 2 wherein the electric controller is configured to determine the required amount of powertrain torque in dependence upon the difference between the instant speed of the vehicle and the required speed value.

4. A system according to claim 3 wherein the electric controller is configured to determine the required amount of powertrain torque in dependence upon the magnitude of the difference between the instant speed of the vehicle and the required speed value.

5. A system according to claim 2 wherein the means for determining automatically when a powertrain torque interruption occurs comprises the electric controller being configured to receive electrical signals indicative of when a powertrain torque interruption occurs.

6. A system according to claim 5 wherein the means for determining automatically when a powertrain torque interruption occurs comprises the electric controller being configured to receive one or more electrical signals indicative of a gear change taking place.

7. A system according claim 1 configured to resume changes in required speed value according to the predetermined speed profile in dependence upon receipt of one or more electrical signals indicative that powertrain torque interruption has ceased.

8. A system according to claim 7 wherein resumption takes place according to the predetermined speed profile from a speed value of the profile substantially equal to the instant speed of a vehicle when the torque interruption ceases.

9. A system according to claim 1 configured substantially to prevent a change in required speed value during the period of powertrain torque interruption.

10. A system according to claim 1 configured to limit a rate of change of required speed value, or to limit an amount by which the required speed value may change, during the period of powertrain torque interruption.

11. A system according to claim 2 wherein said electronic controller comprises a proportional-integral (PI) feedback control portion, the PI control portion comprising a proportional element configured to output a proportional signal that is proportional to a difference between the instant vehicle speed and required speed value, and an integral element configured to output an integral signal that corresponds to an integrated value over time of the difference between the instant vehicle speed and the required speed value, wherein during a period of torque interruption the system is configured substantially to suspend changes in the proportional signal and the integral signal.

12. A vehicle comprising a body, a plurality of wheels, a powertrain to drive said wheels, a braking system to brake said wheels, and a system according to claim 1.

13. A method of automatically controlling the speed of a vehicle in accordance with a target speed value implemented by means of a control system, said method comprising:
causing automatically a vehicle to travel at a required speed value at least in part by controlling an amount of torque applied to one or more wheels of a vehicle by a powertrain;
causing automatically a change in the required speed value according to a predetermined speed profile thereby to cause a corresponding change in a measured instant speed of a vehicle; and
determining automatically when a powertrain torque interruption occurs,
the method comprising substantially temporarily causing a suspension of changes in required speed value according to the predetermined speed profile when it is determined that a powertrain torque interruption occurs.

14. A method according to claim 13 wherein determining automatically when a powertrain torque interruption occurs comprises determining automatically when a transmission gear change occurs.

15. A method according to claim 14 wherein determining automatically when a transmission gear change occurs comprises receiving a signal indicative of a transmission gear change.

16. A non-transitory carrier medium carrying computer readable code for controlling a vehicle to carry out the method of claim 13.

17. A speed control system having a processor configured so as to implement the method of claim 13.

18. A vehicle comprising the speed control system of claim 17.

19. A processor arranged to implement the method of claim 13.

20. (canceled)
